(19) United States
(12) Patent Application Publication
(10) Pub. No.: US 2025/0269923 A1
(43) Pub. Date: Aug. 28, 2025

(54) FRONT DRIVE WHEEL AND AN ELECTRIC TRICYCLE

(71) Applicant: Razor USA LLC, Cerritos, CA (US)

(72) Inventors: Terry Guo, Shanghai (CN); Jerry Tao, Shanghai (CN); Louis Lu, Shanghai (CN)

(21) Appl. No.: 19/059,113

(22) Filed: Feb. 20, 2025

(30) Foreign Application Priority Data
Feb. 23, 2024 (CN) 2024102019716
Feb. 23, 2024 (CN) 2024203465419

(51) Int. Cl. B62K 5/027; B62M 6/45

(52) U.S. Cl. CPC B62K 5/027; B62M 6/45

(57) ABSTRACT

A front-drive wheel and an electric tricycle are disclosed. The front-drive wheel comprises: a hub and an iron core assembly disposed within the hub, wherein the iron core assembly is connected to an electronic control system in the front fork assembly, a rotating shaft extends through the iron core assembly, with both ends respectively extending to opposite axial sides of the hub. A pedal mechanism is positioned at both ends of the rotating shaft. In the aforementioned front-drive wheel, the iron core assembly is arranged inside the hub to meet the requirements for electric driving. Meanwhile, pedal mechanisms are provided at both opposite ends of the rotating shaft, thereby enabling manual riding in the absence of electrical power. As a result, the front-drive wheel of the present application offers two driving modes, enhancing operational flexibility.

### PRIORITY

This application claims priority to Chinese Patent Application No. 2024102019716, filed Feb. 23, 2024 and Chinese Patent Application No. 2024203465419, filed Feb. 23, 2024, the entirety of which are incorporated by reference herein.

All applications for which a foreign or domestic priority claim is identified in the Application Data Sheet as filed with the present application are hereby incorporated by reference herein.

### TECHNICAL FIELD

The disclosure generally relates to electric tricycles, and more particularly relates to front-drive vehicles and electric tricycles.

### BACKGROUND

Electric tricycles are increasingly favored by people because of their energy-saving, flexible steering, cost-effectiveness, and high riding safety. They have become a popular recreational toy for children to ride and relax.

However, front-wheel drive electric tricycles can only operate when powered by electricity. When there is no power supply, the tricycles will not operate, and the rider will have to wait for recharging, which is very passive.

Based on this situation, the present application discloses a front-drive wheel and an electric tricycle with a view to address the above technical issues.

### SUMMARY

The technical problem to be solved is to overcome the defects of the front-drive tricycle operating in a single way in the prior art, thereby a front-drive wheel and an electric tricycle are disclosed in the present application.

The present application intends to solve the above technical problems through the following technical solutions:

One aspect of the present disclosure is a front-wheel drive wheel, comprising:
a hub and an iron core assembly sleeved within the hub, wherein the iron core assembly is connected to an electronic control system in a front fork assembly;
a rotating shaft extending through the iron core assembly, with both ends of the rotating shaft respectively extending to opposite axial sides of the hub, wherein a fastening member is disposed in the iron core assembly and configured to connect with a connecting member in the front fork assembly; and wherein pedal mechanisms are arranged at both opposite ends of the rotating shaft.

According to one example of the present disclosure, a first side cover and a second side cover are arranged on opposite sides of the hub, wherein the first side cover and the second side cover are secured to the hub via at least one threaded connecting member.

A one-way driving mechanism is disposed between the first side cover and the rotating shaft, and the one-way driving mechanism is sleeved on the outer side of the rotating shaft and is connected to the first side cover.

According to one example of the present disclosure, a first limiting structure is positioned between the one-way driving mechanism and the rotating shaft, and a second limiting structure is positioned between the one-way driving mechanism and the first side cover, and wherein the one-way driving mechanism is a one-way bearing or a freewheel.

According to one example of the present disclosure, the fastening member is a fixed pin, wherein one of the ends of the fixed pin is securely connected to the iron core assembly.

Another aspect of the disclosure is an electric tricycle, comprising:
a front fork assembly comprising an electronic control system;
the front-drive wheel as aforementioned, wherein the front-drive wheel is connected to the front fork assembly.

According to one example of the present disclosure, a fixing pin base is disposed in the front fork assembly, wherein the fixing pin base is detachably connected to the fastening member.

According to one example of the present disclosure, the fixing pin base is sleeved on the outer side of the fastening member and forms a limiting in conjunction with the fastening member.

According to one example of the present disclosure, a power source and a start button are also included in the front fork assembly, wherein the power source and the start button are respectively connected to the electronic control system, and the iron core assembly is electrically connected to the electronic control system.

According to one example of the present disclosure, the front fork assembly comprises a first connecting rod and a second connecting rod, wherein the first connecting rod and the second connecting rod are respectively disposed on opposite sides of the hub; wherein the first connecting rod and the second connecting rod are connected to the rotating shaft via a rotating assembly.

According to one example of the present disclosure, the rotating assembly comprises a second bearing and a cover sleeved on the outer side of the second bearing; wherein the first connecting rod or the second connecting rod is connected to the cover, and the second bearing is sleeved on the outer side of the rotating shaft.

The positive progressive effect of the application is:

This application provides a front drive wheel with an iron core assembly on the inner side of the hub to meet the demand for electric drive, and at the same time, a pedal mechanism is provided at the opposite ends of the rotating shaft, thereby meeting the demand for riding in the absence of electricity, and thus the front drive wheel provided by the disclosure has two types of drive methods and operates in a more flexible manner.

The electric tricycle provided by the application includes the front-drive wheels described above, so it has all the beneficial effects of the front-drive wheels, which will not be repeated herein.

### BRIEF DESCRIPTION OF THE DRAWINGS

The foregoing and other features, properties and advantages of the present application will become more apparent by the following description in conjunction with the accompanying drawings and embodiments, wherein:

FIG. 1 shows a schematic diagram of the partial structure of the application electric tricycle;

FIG. 2 shows a schematic structure of the front drive wheel of FIG. 1;

FIG. 3 shows a schematic diagram of the exploded structure shown in FIG. 2;

FIG. 4 shows a cross-sectional view of an angle of FIG. 1.

1: Hub; 11: First side cover; 12: Second side cover; 13: One-way drive mechanism; 14: First limiting structure; 15: Second limiting structure;

2: Core assembly; 21: Fastening member;

3: Front fork assembly; 31: Electronic control system; 33: Fixing pin base; 34: Power supply; 35: Start button; 36: First connecting rod; 3: Second connecting rod; 38: Rotating assembly; 381: Second bearing; 382: Cover body;

4: Rotating shaft; 41: pedal mechanism.

### DETAILED DESCRIPTION

The application is further described hereinafter in connection with specific embodiments and the accompanying drawings, and more details are set forth in the following description in order to facilitate a full understanding of the application. But the application is obviously capable of being implemented in a variety of other ways different from those described herein, and the people skilled in the field can make similar promotions and deductions according to the actual application without violating the connotation of the application. Therefore, the scope of protection of the application should not be limited by the contents of the specific embodiments.

Unless otherwise defined, all technical and scientific terms used herein have the same meanings as are commonly understood by those skilled in the field of this application; the terms used herein are for the purpose of describing specific embodiments only, and are not intended to limit this application; the terms “comprising” and “having” and any variations thereof, as used in the specification and the claims of this application, and in the foregoing description of the drawings, are intended to cover non-exclusive embodiments.

In addition, it should be noted that the use of terms such as “first” and “second” to qualify the parts and components is only for the purpose of facilitating the differentiation of the corresponding parts and components, and the said terms do not have special meanings if not otherwise declared, and therefore cannot be understood as a limitation of the scope of protection of the present application. In addition, although the terms used in this application are selected from the publicly known common terms, some of the terms mentioned in the specification of this application may have been selected by the applicant according to his or her judgment, and the detailed meanings thereof are described in the relevant portions of the description herein. In addition, it is required that this application be understood not only by the actual terms used, but also by the meaning implied by each term.

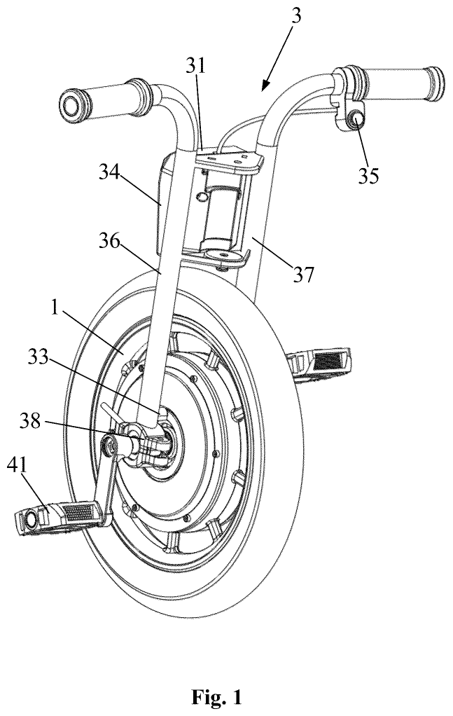

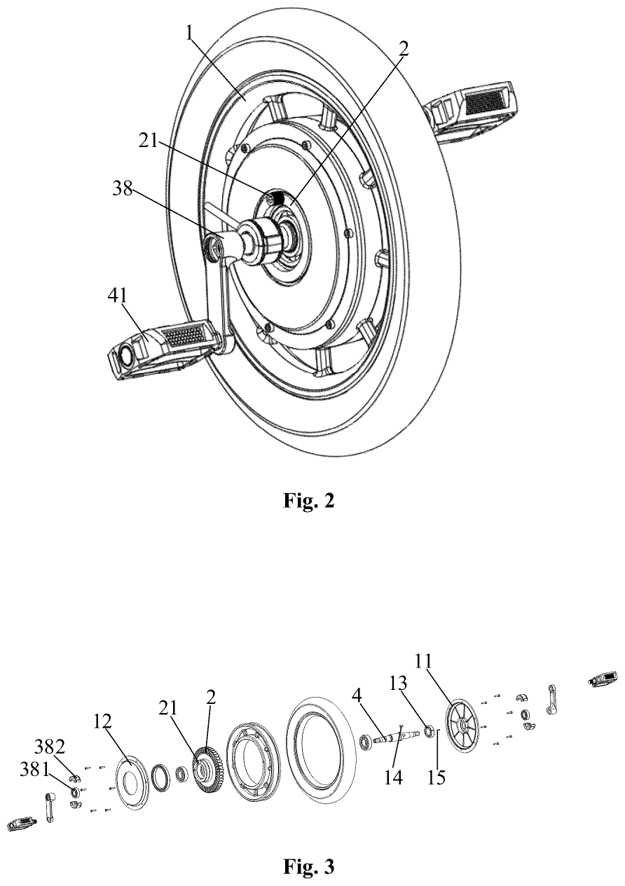

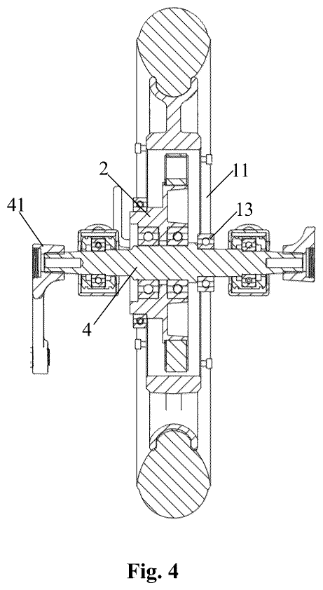

Referring to FIGS. 1 to 4, the application provides an electric tricycle comprising a front fork assembly 3 and a front drive wheel, the front drive wheel being coupled to the front fork assembly 3.

It is to be noted that the electric tricycle provided by the application has a front wheel drive method.

Specifically, the front drive wheel includes a hub 1 and an iron core assembly 2 sleeved within the hub 1, the iron core assembly 2 being electrically connected to an electrical control system 31 in the front fork assembly 3.

The rotating shaft 4 extends through the iron core assembly 2, with both ends of the rotating shaft extending to opposite sides of the hub 1 in the axial direction, and the iron core assembly 2 is provided with a fastening member 21 for connecting with a connecting member (the connecting member corresponds to the fixing pin base 33 as described below) provided on the fork assembly 3. Therein, a pedal mechanism 41 is provided at the opposite ends of the pedal mechanism 41.

That is, the front-drive wheel provided by the application comprises two driving modes. Among them, the first driving mode is an electric driving mode realized by using the iron core assembly 2, which is also a conventional operation mode of the electric tricycle. The second driving mode is a non-electric driving mode realized by using the pedal mechanism 41, which is a non-electric driving mode, i.e., when the power supply 34 of the electric tricycle is out of power, the user can drive the electric tricycle by using the pedal mechanism 41, avoiding the inconvenience of pushing the electric tricycle all manually in the state of no power.

As a result, the application of the electric tricycle can meet the relatively convenient driving needs in both the electric and non-electric state, thus avoiding the defects in the non-electric state that can only be manually pushed.

Specifically, the hub 1 is provided with a first side cover 11 and a second side cover 12 on opposite sides, and the first side cover 11 and the second side cover 12 are fixedly connected to the hub 1 by at least one threaded connector; the first side cover 11 is provided with a one-way drive mechanism 13 between the first side cover 11 and the rotating shaft 4, and the one-way drive mechanism 13 is set on the outer side of the rotating shaft 4 and connected to the first side cover 11.

The first side cover 11 and the second side cover 12 are provided on opposite sides of the iron core assembly 2 and are connected to the hub 1, which on the one hand can form a sealing protection for the iron core assembly 2 to avoid the influence of the external environment on the operation of the iron core assembly 2; on the other hand, the first side cover 11 can also be used as a force transmitting member to transmit the rotational force of the rotating shaft 4 to the hub 1 in one direction.

Specifically, when the electric tricycle is in a powerless state, the user steps on the pedal mechanism 41 to drive the rotating shaft 4 to rotate, and then the rotating shaft 4 drives the one-way drive mechanism 13, the first side cover 11, and the wheel hub 1 to rotate in turn, and there is a tire on the outside of the wheel hub 1, which realizes the pedal drive for the front-drive wheels in a powerless state, and then avoids the defect that the electric tricycle can only be manually pushed in a powerless state.

In one embodiment, for the first side cover 11 and the second side cover 12, a plurality of threaded connectors may be uniformly disposed along the outer circumference of the first side cover 11 and the second side cover 12 for connecting with the hub 1. The threaded connectors may, but are not limited to, bolts.

In some other embodiments, welding may also be used between the first side cover 11 and the second side cover 12 and the hub 1, without limitation herein. The use of bolt connectors in this application is to facilitate the opening of the first side cover 11 and the second side cover 12 when the iron core assembly 2 needs to be repaired, in order to improve the disassembly and repair efficiency of the iron core assembly 2.

Further, a first limiting structure 14 is provided between the one-way driving mechanism 13 and the rotating shaft 4, and a second limiting structure 15 is provided between the one-way driving mechanism 13 and the first side cover 11, and the one-way driving mechanism 13 is a one-way bearing or a flywheel. The unidirectional bearing is illustrated as an example in this application embodiment, but this is not limited.

The first limiting structure 14 and the second limiting structure 15 may be flat keys, and under the action of the first limiting structure 14, the second limiting structure 15, and the unidirectional bearing, the front drive wheels may be unidirectionally driven.

In one embodiment, the fixing member 21 is a fixing pin, and the front fork assembly 3 is provided with a fixing pin base 33, which is removably connected to the fixing pin.

Specifically, the fixing pin base 33 is socketed to the outside of the fixing pin and is coupled to the fixing pin.

It is to be noted that one end of the fixing pin is fixedly connected to the iron core assembly 2, and the other end is inserted in the fixing pin base 33. The iron core assembly 2 is energized to drive the rotating shaft 4 to rotate, and in turn, the rotating shaft 4 can further drive the hub 1 to rotate, completing the electric driving process of the electric tricycle. The fixing pin base 33 is provided to limit the relative movement between the iron core assembly 2 and the rotating shaft 4. The driving principle of the brushless motor is well known to the technicians in the field and will not be repeated herein.

In this embodiment, the fixing pin base 33 is used to form a limit to the fixing pin to fix the iron core assembly 2. The fixing pin is a pin structure provided protruding from the side of the iron core assembly 2. Correspondingly, the fixing pin base 33 may be a U-shaped structure, and the fixing pin is inserted into the U-shaped structure to realize relative fixation of the fixing pin and the fixing pin base 33, and the opening of the U-shaped structure is facing downward, which also facilitates removal of the wheel.

In one embodiment, the front fork assembly 3 is further provided with a power supply 34 and a start button 35, the power supply 34 and the start button 35 being connected to the electronic control system 31, respectively, and the iron core assembly 2 being electrically connected to the electronic control system 31.

It is to be noted that the electric tricycle is driven in the electric drive mode by pressing the start button 35, the drive signal is transmitted to the electronic control system 31, and the power supply 34 provides power to the iron core assembly 2 to realize the drive.

With the electric tricycle in a non-electric drive mode, the user may press on the foot pedal mechanism 41 to drive the front drive wheels forward.

Specifically, the front fork assembly 3 includes a first connecting rod 36 and a second connecting rod 37, the first connecting rod 36 and the second connecting rod 37 being disposed on opposite sides of the hub 1, and the first connecting rod 36 and the second connecting rod 37 being coupled to the rotating shaft 4 via the rotating assembly 38.

Further, the rotating assembly 38 comprises a second bearing 381 and a cover body 382 socketed on the outside of the second bearing 381, the first connecting rod 36 or the second connecting rod 37 being coupled to the cover body 382, and the second bearing 381 being socketed on the outside of the rotating shaft 4.

The two rotating assembly 38 are used to provide support to the front fork assembly 3 and to improve the operational stability of the pedal mechanism 41.

Specifically, the cover body 382 is fitted with two removable cover plates, which are respectively set on the outer side of the rotating shaft 4 and connected using threaded connectors. The front fork assembly 3 can thus be disassembled separately, which in turn facilitates the installation and maintenance of the front fork assembly 3 and the front drive wheel separately, and improves the efficiency of their disassembly and maintenance.

In summary, the application provides a front-drive wheel with an iron core assembly 2 on the inside of the hub 1 to meet the demand for electric drive, and at the same time, a pedal mechanism 41 is provided at the opposite ends of the rotating shaft 4, thereby meeting the demand for riding in the absence of electricity, and thus the front-drive wheel provided by the application has two types of drive methods, and operates in a more flexible manner.

This application embodiment integrates the motor drive mechanism and the pedal mechanism in the front wheel of the vehicle, so that the front wheel of the vehicle can be electrically driven as well as pedal-riding, and the pedal mechanism is directly mounted on the rotating shaft of the front wheel to ensure that the front wheel can be steered normally when pedal-riding, so that the pedal mechanism and the steering of the front wheel do not affect each other, forming a new type of front-wheel drive mode. This is an improvement based on existing front-wheel drive vehicles, which makes the vehicle more practical and fun.

In the description of the embodiments of this application, unless otherwise expressly provided and limited, the technical terms “mounting”, “connected”, “linked”, “fixed” and the like shall be broadly construed, for example, it may be a fixed connection, or a detachable connection, or a one-piece; or it may be a mechanical connection. For a person of ordinary skill in the field, the specific meanings of the aforesaid terms in the embodiments of the present application may be construed in accordance with the specific circumstances.

The present application uses specific terms to describe embodiments of the present application. For example, “an embodiment”, “one embodiment”, and/or “some embodiments” are meant to refer to a particular feature, structure, or characteristic associated with at least one embodiment of the present application. Accordingly, it should be emphasized and noted that two or more references to “an embodiment” or “one embodiment” or “an alternative embodiment” in different places in this specification do not necessarily refer to the same embodiment. In addition, certain features, structures, or characteristics of one or more embodiments of the present application may be suitably combined. Similarly, it should be noted that, in order to simplify the presentation of the disclosure of the present application so as to assist in the understanding of one or more embodiments of the application, the foregoing descriptions of the embodiments of the present application sometimes combine a variety of features into a single embodiment, accompanying drawings, or descriptions thereof. However, this method of disclosure does not imply that more features are required for the objects of the present application than those mentioned in the claims. In fact, the embodiments have fewer features than all of the features of the single embodiment disclosed above.

Although the application is disclosed as above with better embodiments, it is not intended to limit the application, and any person skilled in the field can make possible changes and modifications without departing from the spirit and scope of the application. Therefore, any modifications, equivalent changes and modifications made to the above embodiments based on the technical substance of the application without departing from the content of the technical program of the application will fall within the scope of protection defined in the claims of the application.

1. A front-drive wheel, comprising:
a hub and an iron core assembly sleeved within the hub, wherein the iron core assembly is connected to an electronic control system in a front fork assembly;
a rotating shaft extending through the iron core assembly, the rotating shaft comprising a first end and a second end opposite then first end, with both the first and second ends of the rotating shaft respectively extending to opposite sides of the hub in an axial direction, wherein a fastening member is disposed in the iron core assembly and configured to connect with a connecting member in the front fork assembly; and
wherein pedal mechanisms are arranged at the first and second ends of the rotating shaft.

2. The front-drive wheel according to claim 1, wherein a first side cover and a second side cover are arranged on opposite sides of the hub, wherein the first side cover and the second side cover are secured to the hub via at least one threaded connecting member; and
wherein a one-way driving mechanism is disposed between the first side cover and the rotating shaft, and the one-way driving mechanism is sleeved on an outer side of the rotating shaft and is connected to the first side cover.

3. The front-drive wheel according to claim 2, wherein a first limiting structure is positioned between the one-way driving mechanism and the rotating shaft, and a second limiting structure is positioned between the one-way driving mechanism and the first side cover, and wherein the one-way driving mechanism is a one-way bearing or a freewheel.

4. The front-drive wheel according to claim 1, wherein, the fastening member is a fixed pin, wherein an end of the fixed pin is securely connected to the iron core assembly.

5. An electric tricycle, comprising:
a front fork assembly comprising an electronic control system;
the front-drive wheel according to claim 1, wherein the front-drive wheel is connected to the front fork assembly.

6. The electric tricycle according to claim 5, wherein a fixing pin base is disposed in the front fork assembly, wherein the fixing pin base is detachably connected to the fastening member.

7. The electric tricycle according to claim 6, wherein the fixing pin base is sleeved on an outer side of the fastening member and forms a limit in conjunction with the fastening member.

8. The electric tricycle according to claim 5, wherein a power source and a start button are also included in the front fork assembly, wherein the power source and the start button are respectively connected to the electronic control system, and the iron core assembly is electrically connected to the electronic control system.

9. The electric tricycle according to claim 5, wherein the front fork assembly comprises a first connecting rod and a second connecting rod, wherein the first connecting rod and the second connecting rod are respectively disposed on opposite sides of the hub;
wherein the first connecting rod and the second connecting rod are connected to the rotating shaft via a rotating assembly.

10. The electric tricycle according to claim 9, wherein the rotating assembly comprises a second bearing and a cover sleeved on an outer side of the second bearing;
wherein the first connecting rod or the second connecting rod is connected to the cover, and the second bearing is sleeved on an outer side of the rotating shaft.
